(19) United States
(12) Patent Application Publication
(10) Pub. No.: US 2018/0222387 A1
(43) Pub. Date: Aug. 9, 2018

(54) Blind Zone Monitoring Method, License Plate Frame Device with Blind Zone Monitoring Function and Rearview Mirror

(71) Applicant: Shenzhen Xiaofeida Electronic Co., Ltd, Shenzhen (CN)

(72) Inventor: Xiaofei Wu, Shenzhen (CN)

(21) Appl. No.: 15/674,669

(22) Filed: Aug. 11, 2017

(30) Foreign Application Priority Data
Feb. 7, 2017 (CN) 201710067103.3
Jun. 26, 2017 (CN) 201710495113.7

(51) Int. Cl. B60Q 9/00; G01S 19/03; B60R 1/06; B60R 1/12; B60R 13/10; G01S 13/93; G01S 19/13

(52) U.S. Cl. CPC B60Q 9/008; G01S 19/03; B60R 1/06; B60R 1/12; G01S 2013/9332; G01S 13/931; G01S 19/13; B60R 2001/1215; B60R 13/10

(57) ABSTRACT

The present invention discloses a blind zone monitoring method, a license plate frame device with a blind zone monitoring function, and a rearview mirror. A radar sensor is mounted inside a license plate frame body or the automobile rearview mirror to assist in information monitoring of the blind zone of the automobile rearview mirror. The whole process can be completed rapidly and easily, collision accidents caused by lane changing or turning of the automobile are avoided, and driving is safer. In addition, the entire blind zone monitoring device is arranged inside the license plate frame body without affecting the attractiveness of the automobile and is extremely convenient to mount and use.

### CROSS REFERENCE TO RELATED APPLICATIONS

The present application claims the benefit of Chinese Patent Application Nos. 201710067103.3 filed on Feb. 7, 2017 and 201710495113.7 filed on Jun. 26, 2017. All the above are hereby incorporated by reference.

### BACKGROUND OF THE INVENTION

1. Technical Field

The present invention relates to the technical field of electronic control of automobiles, in particular to a license plate frame device with a blind zone monitoring function, a rearview mirror and a blind zone monitoring method.

2. Description of Related Art

When lane changing or turning is required by an automobile, the driver generally confirms the traveling states and positions of automobiles behind by observing rearview mirrors so as to determine whether the lane changing or turning behavior can be carried out or not. However, existing rearview mirrors are all made of bent glass, due to the limitation of the curvature of the rearview mirror glass, when the distance between the position of the automobile behind and the position of the automobile in front is only the length of half of an automobile body, the image of the automobile behind right falls into the vision blind zones of the rearview mirrors, the driver cannot see the automobile behind consequentially, and lateral collision accidents occur extremely easily if lane changing or turning is carried out at the moment. In heavy fog, heavy rain or snow weather, lens of the rearview mirrors are fuzzy, and lateral collision accidents can also occur extremely easily if lane changing or turning is carried out. In the prior art, several distance monitoring devices are generally mounted at the two ends of the automobile body or at the positions of the rearview mirrors to detect the distance between automobiles, so that the defects of blind zones of the rearview mirrors are overcome. However, the monitoring devices are generally mounted outside, and consequentially the attractiveness of the automobiles is affected.

### BRIEF SUMMARY OF THE INVENTION

For overcoming the defects of the above technique, the present invention provides a blind zone monitoring method, a license plate frame device with a blind zone monitoring function and a rearview mirror; a distance monitoring radar is mounted in a license plate frame body, so that the appearance of an automobile is not affected, motions of the automobile can be automatically monitored in real time, and particularly, the automobile rearview mirror is assisted in blind zone monitoring.

For realizing the above purposes, the present invention discloses a blind zone monitoring method; radar sensors and a main control panel are included, the radar sensors are connected with the main control panel and mounted on the left side and the right side of an automobile, and the main control panel is arranged in the automobile and connected with an automobile main controller; when the automobile travels:
receiving and processing the automobile speed monitored by a GPS module and the vehicle traveling conditions, monitored by the radar sensors, in the blind zones at the two ends of the automobile through the main control panel;
detecting whether a moving object exists in the blind zones of the rearview mirror or not in real time, automatically detecting the distance between the object and the automobile if the moving object exists, and sending signals to a main control module through the radar sensors; when the radar sensors detect that the moving object exists in the blind zones and the distance between the moving object and the automobile is smaller than the early warning distance;
sending an abnormal signal to the automobile main controller through the main control panel, and controlling a corresponding indicator to give an alarm as a prompt through the automobile main controller;
when the main control panel detects that the distance between the moving object in the blind zones and the automobile is smaller than the early warning distance and a steering lamp signal towards the moving object exists in the automobile main controller,
sending an abnormal signal to the automobile main controller through the main control panel, and controlling the corresponding indicator to give an alarm as a prompt through the automobile main controller.
when the information indicating that the moving object exists in the blind zone is received, automatically acquiring the automobile speed signal in the GPS module and judging whether the automobile speed exceeds the early warning automobile speed or not through the main control panel;
when the automobile speed exceeds the early warning automobile speed, sending an abnormal signal to the automobile main controller through the main control panel;
controlling the corresponding indicator to give an alarm and light up through the automobile main controller;
reading the automobile steering lamp information in the automobile main controller in real time and automatically judging whether an automobile steering lamp signal towards the moving object exists or not through the main control panel;
when the automobile steering lamp signal meeting the requirement exists, transmitting an abnormal signal to the automobile main controller through the main control panel, controlling the corresponding indicator to give an alarm through the automobile main controller, and reminding the driver of turning dangers.

The present invention further discloses a license plate frame device with a blind zone monitoring function; the license plate frame device with the blind zone monitoring function comprises a license plate frame body, a radar sensor and a main control panel, wherein the license number is displayed on an external baffle of the license plate frame body, the radar sensor and the main control panel are arranged inside the license plate frame body, the radar sensor is electrically connected with the main control panel, the main control panel is electrically connected with an automobile main controller and used for acquiring a power supply and transmitting data, the main control panel acquires automobile steering information through the automobile main controller and adopts the blind zone monitoring method in the description above, an indicator is arranged in an automobile cab and electrically connected with the automobile main controller, the main control panel sends a signal monitored by the radar sensor to the automobile main controller, and the automobile main controller controls the indicator to act so as to remind the driver to pay attention to the driving condition.

Wherein, the number of the radar sensors is two, the two radar sensors are mounted at the left end and the right end of the license plate frame body respectively, a left radar device and a right radar device are electrically connected with the main control panel respectively, the left radar device is used for monitoring the road condition on the left side of the automobile, the right radar device is used for monitoring the road condition on the right side of the automobile, and the left radar device and the right radar device are electrically connected with the main control panel respectively.

Wherein, the indicator comprises a voice alarm module and an LED indication module, the voice alarm module and the LED indication module are electrically connected with the automobile main controller respectively, the voice alarm module controls a horn to send out alarm sounds after the automobile main controller receives an abnormal signal sent by the radar sensor, and the LED indication module controls an LED lamp to emit warning light.

Wherein, the number of the indicators is two, the left indicator and the right indicator are electrically connected with the automobile main controller respectively, and the automobile main controller sends the monitoring information of the left radar device to the left indicator and simultaneously sends the monitoring information of the right radar device to the right indicator, and the left indicator is arranged on the left side of the right indicator.

Wherein, the main control panel comprises main a control module, an information receiving module and an information sending module, the information receiving module and the information sending module are electrically connected with the main control module, the information receiving module is electrically connected with the radar sensors and receives radar monitoring information sent by the radar sensors, the main control module is used for data processing of the radar monitoring information and transmits abnormal information to the automobile main controller through the information sending module, and the automobile main controller sends the abnormal information to the indicators as a prompt.

Wherein, the main control panel further comprises a GPS modules, the GPS module is electrically connected with the main control module, the radar sensors and the main control panel acquire a power supply through the automobile main controller, the main control panel acquires a steering lamp signal through the automobile main controller, the GPS module measures the automobile speed and sends measured automobile speed signals to the main control module, the radar sensors monitor the vehicle conditions in blind zones of automobile rearview mirrors in real time and transmit information to the main control module, the main control module acquires the automobile speed signal in the GPS module in real time and sends information subjected to data processing into the automobile main controller, and the working states of the indicators are controlled accordingly.

Wherein, the blind zone position parameter, the early warning distance and the early warning automobile speed are set in the main control module, the radar sensors monitor objects by acquiring the blind zone position parameter in the main control module, the left radar sensor acquires left blind zone position parameter information in the automobile main controller, and the right radar sensor acquires right blind zone position parameter information in the automobile main controller.

Wherein, the license plate frame body is of a square structure, the radar sensors are arranged at the two end positions in the license plate frame body, an included angle is formed between the left radar sensor and the left short edge of the license plate frame body, an included angle is formed between the right radar sensor and the right short edge of the license plate frame body, the monitoring scope of the left radar sensor covers a left blind zone, and the monitoring scope of the right radar sensor covers a right blind zone.

A storing device comprises an execution program storing the blind zone monitoring method described above, and the program is stored in the automobile main controller or the main control module.

The present invention further discloses a rearview mirror which comprise a shell, a reflector and a main control panel, wherein the main control panel is embedded in an airtight cavity defined by the shell and the reflector, the main control panel adopts the blind zone monitoring method in the description above, the radar sensor and the indicator are electrically connected with the main control panel, the main control panel is electrically connected with the automobile main controller and also electrically connected with the indicator, an indicator display area is further arranged at the junction of the shell and the automobile, a transparent plastic cover plate is arranged in the indicator display area, and lamplight of the indicator lamp is diffused out through the transparent plastic cover plate in the indicator display area.

The present invention has the beneficial effects that:

Compared with the prior art, the blind zone monitoring method, the license plate frame device with the blind zone monitoring function and the rearview mirror disclosed by the present invention have the beneficial effects that the radar sensor is mounted inside the license plate frame body or the rearview mirror to assist in information monitoring of the blind zone of the automobile rearview mirror, the radar sensor detects whether a moving object exists in the blind zone or not in real time and automatically judges the distance between the moving object and the automobile and the traveling speed of the automobile when monitoring the moving object, an abnormal signal is sent to the automobile main controller through the main control module when the distance is smaller than the early warning distance or the speed is higher than the early warning automobile speed, the automobile main controller controls the indicator to give an alarm, and the driver is warned to pay attention to driving safety accordingly. The whole process can be completed rapidly and easily, collision accidents caused by lane changing or turning of the automobile are avoided, and driving is safer. In addition, the whole blind zone monitoring device is arranged inside the license plate frame body without affecting the attractiveness of the automobile and is extremely convenient to mount and use.

### BRIEF DESCRIPTION OF THE SEVERAL VIEWS OF THE DRAWINGS

FIG. 1 is a module connection diagram of a license plate frame device of an embodiment of the present invention;

FIG. 2 is a structure schematic diagram of the license plate frame device of the embodiment of the present invention;

FIG. 3 is an internal control schematic diagram of the license plate frame device of the embodiment of the present invention;

FIG. 4 is an internal control block diagram of an indicator of the embodiment of the present invention;

FIG. 5 is a block diagram of modules of a main control panel of the embodiment of the present invention;

FIG. 6 is a work flow diagram of a left rearview mirror blind zone monitoring system of the embodiment of the present invention;

FIG. 7 is a work flow diagram of a right rearview mirror blind zone monitoring system of the embodiment of the present invention.

FIG. 8 is a structure schematic diagram of a rearview mirror of a second embodiment of the present invention; and

FIG. 9 is a block diagram of internal control modules of the rearview mirror of the second embodiment of the present invention.

### DESCRIPTION OF MAIN ELEMENTS

1, license plate frame body; 2, radar sensor; 3, main control panel; 4, automobile main controller; 5, indicator; 6, rearview mirror shell; 7, reflector; 3B, main control panel; 21, left radar device; 22, right radar device; 31, main control module; 32, information receiving module; 33, information sending module; 34, GPS module; 51, voice alarm module; 52, LED indication module.

### DETAILED DESCRIPTION OF THE INVENTION

For a clearer illustration of the present invention, a further description of the present invention is given with accompanying drawings as follows.

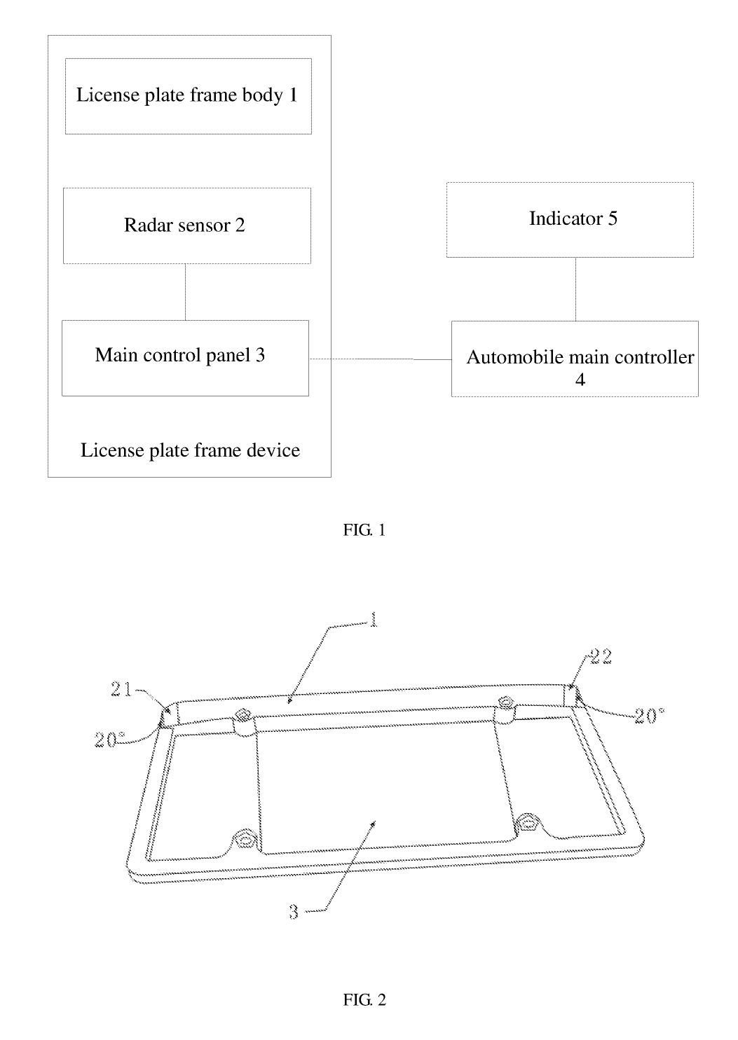

Please see FIG. 1, a license plate frame device with a blind zone monitoring function disclosed by the present invention comprises a license plate frame body 1, a radar sensor 2 and a main control panel 3, wherein the license number is displayed on an external baffle of the license plate frame body 1, the radar sensor 2 and the main control panel 3 are arranged inside the license plate frame body 1, the radar sensor 2 is electrically connected with the main control panel 3, the main control panel 3 is electrically connected with an automobile main controller 4 and used for acquiring a power supply and transmitting data, the main control panel 3 acquires automobile steering information through the automobile main controller 4, an indicator 5 is arranged in an automobile cab and electrically connected with the automobile main controller 4, the main control panel 3 send signals monitored by the radar sensor 2 to the automobile main controller 4, and the automobile main controller 4 controls the indicator 5 to give an alarm so as to remind the driver to pay attention to the driving condition.

Please see FIG. 2, in the embodiment, the number of the radar sensors 2 is two, the two radar sensors 2 are mounted at the left end and the right end of the license plate frame body 1 respectively, the license plate frame body 1 is of a square structure, the radar sensors 2 are arranged at the two end positions in the license plate frame body 1, the included angle between the left radar sensor 21 and the left short edge of the license plate frame body 1 is 20 degrees, and the included angle between the right radar sensor and the right short edge of the license plate frame body 1 is 20 degrees. Through the structural design, the radar sensors 2 right face the blind zones of the rearview mirrors for monitoring, and thus it is guaranteed that the radar sensors 2 can better monitor the blind zones.

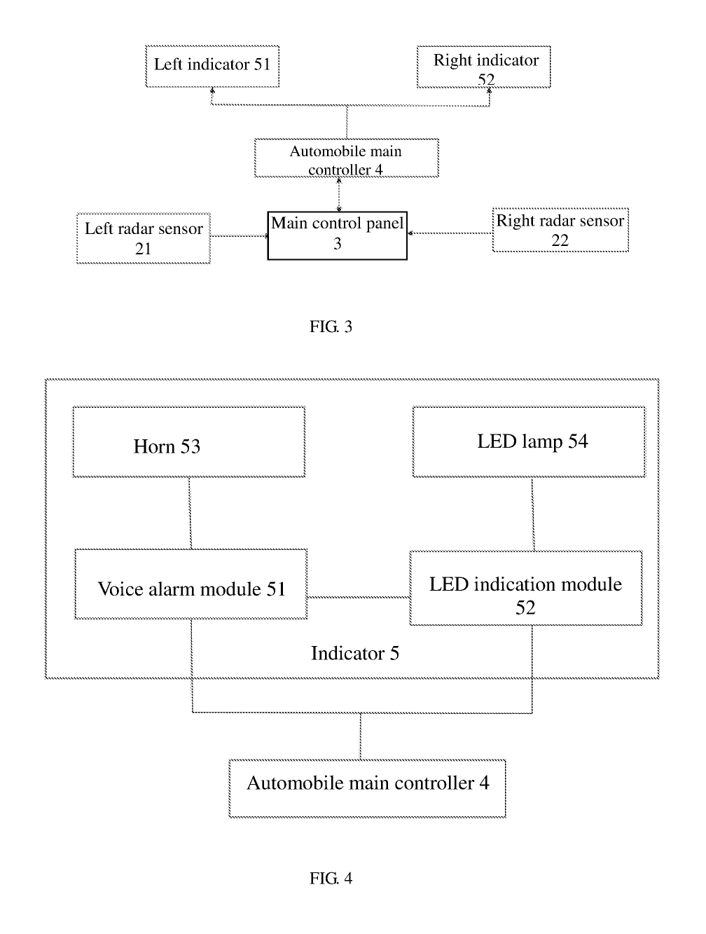

Please see FIG. 3, in the embodiment, the left radar device 21 and the right radar device 22 are electrically connected with the main control panels 3 respectively, the left radar device 21 is used for monitoring the road condition on the left side of the automobile, the right radar device 22 is used for monitoring the road condition on the right side of the automobile, the left radar device 21 and the right radar device 22 are electrically connected with the main control panel 3 respectively, the main control panel 3 is electrically connected with the automobile main controller 4, the automobile main controller 4 controls the left indicator 51 or the right indicator 52 to give an indication alarm according to the abnormal signal sent by the main control panel 3, the driver is reminded of the abnormal condition in a certain blind zone, and thus the driver can drive carefully. In the embodiment, the automobile main controller 4 sends the monitoring information of the left radar device 21 to the left indicator 51 and simultaneously sends the monitoring information of the right radar device 22 to the right indicator 52, and the left indicator 51 is arranged on the left side of the right indicator 52 so that the driver can distinguish the alarmed blind zone more easily and accordingly can give a driving response rapidly.

Please see FIG. 4, the indicator 5 comprises a voice alarm module 51 and an LED indication module 52, wherein the voice alarm module and the LED indication module 52 are electrically connected with the automobile main controller 4 respectively, the voice alarm module 51 controls a horn 53 to send out alarm voice prompt when the automobile main controller 4 receives an abnormal signal sent by the radar sensor 2, the LED indication module 52 controls an LED lamp 54 to emit warning light, and the attention of the driver can be attracted more easily by adoption of the two alarming ways.

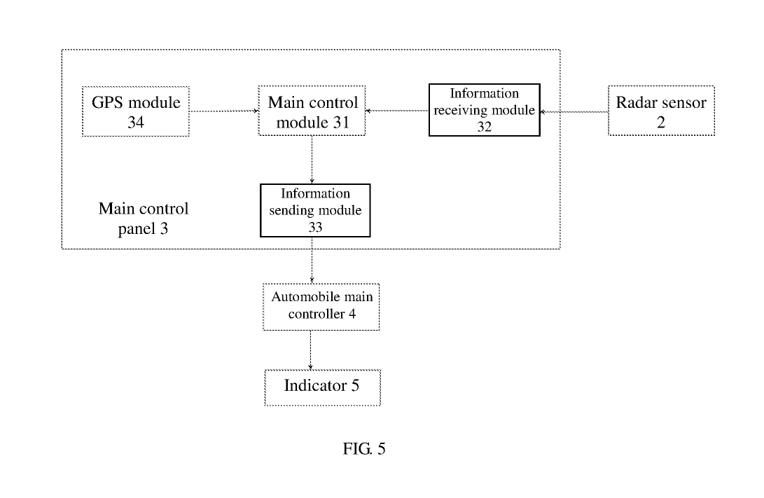

Please see FIG. 5, in the embodiment, the main control panel 3 comprises a main control module 31, an information receiving module 32, an information sending module 33 and a GPS module 34, wherein the information receiving module 32, the information sending module 33 and the GPS module 34 are electrically connected with the main control module 31, the information receiving module 32 is electrically connected with the radar sensor 2 and receives radar monitoring information sent by the radar sensor 2, the main control module 31 is used for data processing of the radar monitoring information and transmits abnormal information to the automobile main controller 4 through the information sending module 33, and the automobile main controller 4 sends the abnormal information to the indicator 5 as a prompt. In the embodiment, the radar sensor 2 and the main control panel 3 acquire a power supply through the automobile main controller 4, the main control panel 3 acquires a steering lamp signal through the automobile main controller 4, the GPS module 34 measures the automobile speed and sends a measured automobile speed signal to the main control module 31, the radar sensor 2 monitors the vehicle condition in the blind zone of the automobile rearview mirror in real time and transmits information to the main control module 31, the main control module 31 acquires the automobile speed signal in the GPS module 34 and sends the information subjected into data processing to the automobile main controller 4, and the working state of the indicator 5 is controlled accordingly.

In the embodiment, the blind zone position parameter, the early warning distance and the early warning automobile speed are set in the main control module 31, the radar sensors 2 monitor objects by acquiring the blind zone position parameter in the main control module, the left radar sensor 21 acquires left blind zone position parameter information in the automobile main controller, and the right radar sensor 22 acquires right blind zone position parameter information in the automobile main controller. In the embodiment, the blind zone position parameter, the early warning distance and the early warning automobile speed can be set according to different automobile types so as to adapt to different types of automobiles and driving groups. In the embodiment, suppose that according to a certain automobile type, the left blind zone and the right blind zone can be covered by setting the included angle between the radar sensor 2 and the license plate frame body 1 to 20 degrees, the early warning distance is 15 m, and the early warning automobile speed is 20 km/h; however, relevant parameters of the present invention are not limited to the above numerical values and can be set automatically according to different automobile types and driving groups, special equipment can be arranged for parameter correction, or a communication module can be arranged in the main control module 31, and parameters can be set through the communication module.

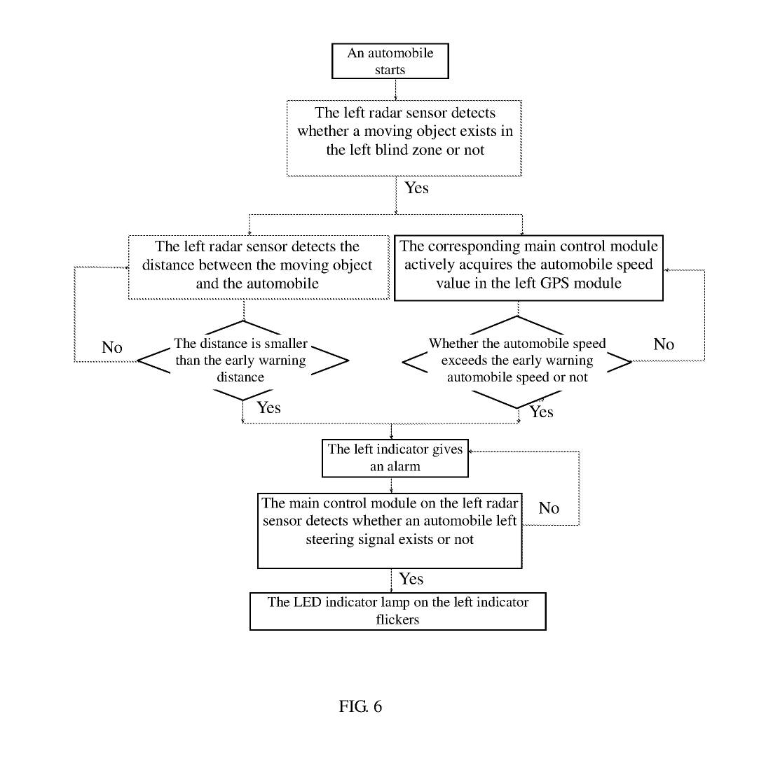

Please see FIG. 6, the specific work flow of the present invention is as follows:

When an automobile travels, the main control panel 34 reads an automobile steering lamp signal sent by the automobile main controller 4 and triggers the left radar sensor 21 and the right radar sensor 22 to acquire corresponding blind zone position parameters from the main control module 31 respectively and to monitor the blind zones in the corresponding monitoring scopes so as to judge whether a moving object enters the corresponding blind zones or not. When a moving object enters the blind zone of the left rearview mirror, the main control module 31 actively acquires the automobile speed in the GPS module 34 and compares the acquired automobile speed with the rated automobile speed value set on the main control module 31; when the acquired automobile speed value exceeds 20 km/h, the main control module 31 sends an abnormal signal to the automobile main controller 4, the left indicator 51 is controlled to given an alarm accordingly for voice prompt, and the left indicator lamp lights up, so that the driver is reminded to drive carefully so as to avoid collision with the object in the left blind zone; meanwhile, the main control module 31 can acquire a steering signal in the automobile main controller 4, when an automobile steering lamp signal for leftward turning is detected, the main control module 31 can control the left indicator lamp to be in the flickering state instead of being in the simple on state, and when no automobile steering lamp signal is detected or the steering lamp signal indicates rightward turning instead of leftward turning, on-off of the left indicator lamp is determined according to the automobile speed value and the distance between the automobile and the moving object in the blind zone. In the embodiment, besides the condition that the automobile speed exceeds 20 km/h, the main control module 31 can also control the left indicator lamp to be kept in the normally-on state when the left radar sensor 21 detects that the distance between the moving object in the left blind zone and the automobile is smaller than 15 m, and the main control module 31 can control the left indicator lamp to flicker when the distance between the moving object and the automobile is smaller than 15 m and a leftward steering signal is detected, so that the driver is warned to pay attention to the automobile speed and the moving object in the blind zone. In the embodiment, the moving object can be a person, or a vehicle or an animal.

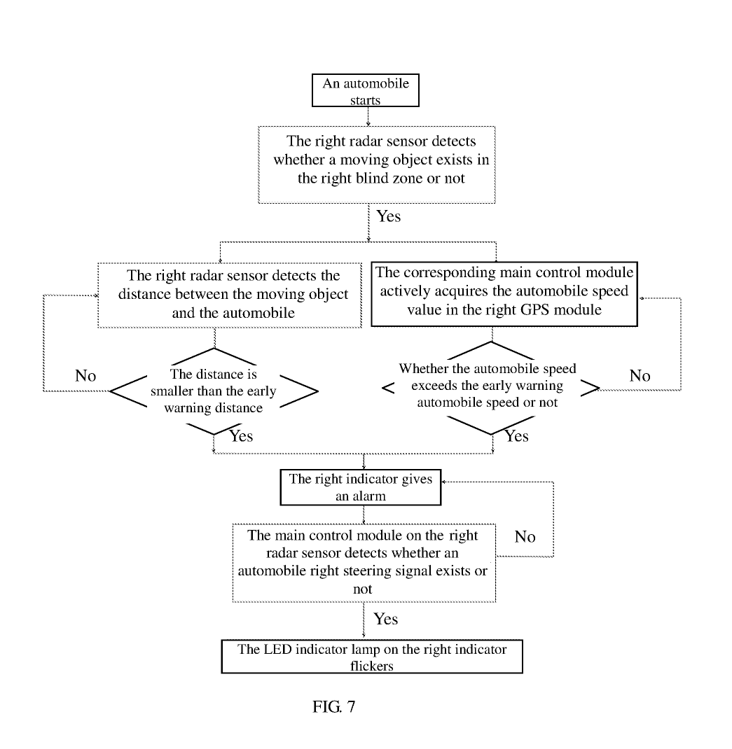

Please see FIG. 7, in the embodiment, when a moving object enters the right blind zone, the main control module 31 actively acquires the automobile speed in the right GPS module 34 and compares the acquired automobile speed with the rated automobile speed value set on the main control module 31, and when the acquired automobile speed value exceeds 20 km/h, the main control module 31 controls the right indicator 52 to give a voice alarm, the LED lamp emits light for alarming, and accordingly the driver is reminded to decelerate so as to avoid collision with the object in the right blind zone; meanwhile, the main control module 31 can acquire a steering signal in the automobile main controller 4 when an automobile steering lamp signal for rightward turning is detected, the main control module 31 can control the right indicator lamp to be in the flickering state instead of being in the simple on state, and when no automobile steering lamp signal is detected or the steering lamp signal indicates rightward turning instead of rightward turning, on-off of the right indicator lamp is determined according to the automobile speed value and the distance between the automobile and the moving object in the right blind zone. In the embodiment, besides the condition that the automobile speed exceeds 20 km/h, the main control module 31 can also control the right indicator lamp to be kept in the normally-on state when the right radar sensor 22 detects that the distance between the moving object in the blind zone and the automobile is smaller than 15 m, and the corresponding main control module 31 can control the right indicator lamp to flicker when the distance between the moving object and the automobile is smaller than 15 m and a rightward steering signal is detected, so that the driver is warned to pay attention to the automobile speed and the moving object in the blind zone.

In the embodiment, the left radar sensor 21 and the right radar sensor 22 work at the same time, and the left indicator lamp and the right indicator lamp are light-emitting diodes which can emit red light or orange light; however, the left indicator lamp and the right indicator lamp are not limited to light-emitting diodes and can also be LED lamps, and all lamps which can achieve the warning function can be applied to the present invention.

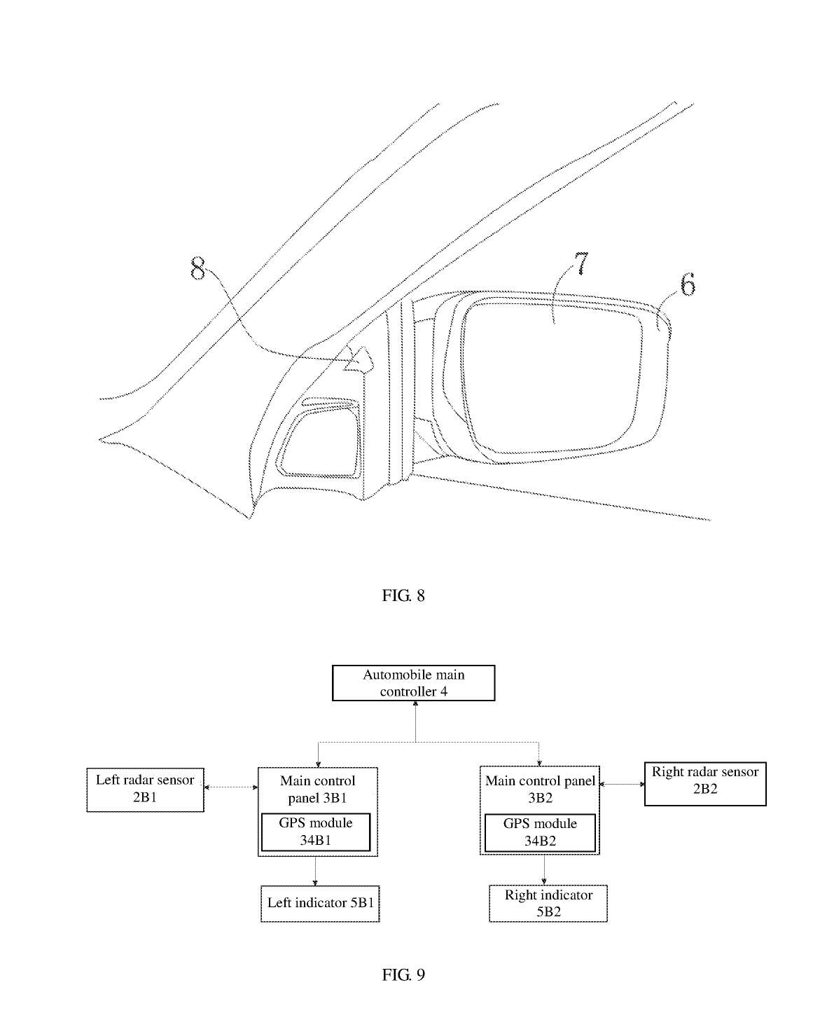

In the embodiment, the invention provides an automobile rearview mirror with a blind zone monitoring system, please see FIGS. 8-9, the automobile rearview mirror comprises a rearview mirror shell 6, a reflector 7 and a main control panel 3B, wherein the main control panel 3B is embedded in an airtight cavity defined by the shell 6 and the reflector 7, the rearview mirror blind zone monitoring system in the above description is arranged on the main control panel 3B, the radar sensor 2B and the indicator 5B are electrically connected with the main control panel 3B, the radar sensor 2B is electrically connected with the automobile main controller 4 and also electrically connected with the indicator 5B, an indicator lamp display area 8 is further arranged at the junction of the rearview mirror shell 6 and the automobile, a transparent plastic cover plate is arranged in the indicator lamp display area 8, and lamplight of the indicator lamp 5B is diffused out through the transparent plastic cover plate in the indicator lamp display area 8, so that the working state of the indicator 5B is displayed; in the embodiments, the indicator display area 8 faces the cab so that the driver can observe the changes of the indicator 5B conveniently. In the embodiment, the way of communication between the radar sensor 2B, the main control panel 3B and the automobile main controller 4 meets the requirement of the method for detecting the blind zone of the rearview mirror; in the embodiment, the operating principle of the rearview mirror blind zone monitoring system of the automobile is as follow:

The number of the rearview mirrors is two, and the two rearview mirrors are the left rearview mirror and the right rearview mirror respectively, and the left radar sensor 2B1 and the right radar sensor 2B2 are arranged correspondingly; in the embodiment, one main control panel 3B can be arranged, the left and right radar sensors are both connected with the main control panel 3B for communication, the left and right radar sensors and the corresponding indicators 5B are controlled to act through the main control panel 3B, and the operating principle is the same as the operating principle of the above license plate frame device. Besides the above structure, the invention further discloses another control method, namely independent main control panels are arranged on the left rearview mirrors and the right rearview mirrors respectively to control the corresponding left radar sensor 2B1 or the right radar sensor 2B2, specifically:

When the automobile travels, the main control panel 3B1 on the left radar sensor 2B1 and the main control panel 3B2 on the right radar sensor 2B2 receive an automobile traveling signal sent by the automobile main controller 4 and activate the blind zone position parameters on the main control panels on the left and right rearview mirrors correspondingly, and thus the blind zones of the left and right rearview mirrors are monitored to check whether a moving object enters the areas of the blind zones or not. When a moving object enters the blind zone of the left rearview mirror, the left radar sensor 2B1 actively acquires the automobile speed in the left GPS module 34B1 of the main control panel 3B1 and compares the acquired automobile speed with the rated automobile speed value set on the main control panel 3B1; when the acquired automobile speed value exceeds 20 km/h, the main control panel 3B1 controls the left indicator 2B1 to light up, so that the driver is reminded to drive carefully so as to avoid collision with the object in the left blind zone; meanwhile, the main control panel 3B1 can acquire a steering signal in the automobile main controller 4, when an automobile steering lamp signal for leftward turning is detected, the main control panel 3B1 can control the left indicator lamp 5B1 to be in the flickering state instead of being in the simple on state, and when no automobile steering lamp signal is detected or the steering lamp signal indicates rightward turning instead of leftward turning, on-off of the left indicator lamp 5B1 is determined according to the automobile speed value and the distance between the automobile and the moving object in the left blind zone; in the embodiment, besides the condition that the automobile speed exceeds 20 km/h, the main control panel 3B1 can also control the left indicator lamp 5B1 to be kept in the normally-on state when the left radar sensor 2B1 detects that the distance between the moving object in the left blind zone and the automobile is smaller than 15 m, and the main control panel 3B1 can control the left indicator lamp 5B1 to flicker when the distance between the moving object and the automobile is smaller than 15 m and a leftward steering signal is detected, so that the driver is warned to pay attention to the automobile speed and the moving object in the blind zone; in the embodiment, the moving object can be a person, or a vehicle or an animal.

In the embodiment, when a moving object enters the right blind zone, the right radar sensor 2B2 actively acquires the automobile speed in the right GPS module 34B2 and compares the acquired automobile speed with the rated automobile speed value set on the main control panel 3B2, and when the acquired automobile speed value exceeds 20 km/h, the main control panel 3B2 controls the right indicator 5B2 to light up, so that the driver is reminded to decelerate so as to avoid collision with the object in the right blind zone; meanwhile, the main control panel 3B2 can acquire a steering signal in the automobile main controller 4 when an automobile steering lamp signal for rightward turning is detected, the main control panel 3B2 can control the right indicator lamp 5B2 to be in the flickering state instead of being in the simple on state, and when no automobile steering lamp signal is detected or the steering lamp signal indicates leftward turning instead of rightward turning, on-off of the right indicator lamp 5B2 is determined according to the automobile speed value and the distance between the automobile and the moving object in the right blind zone. In the embodiment, besides the condition that the automobile speed exceeds 20 km/h, the main control panel 3B2 can also control the right indicator lamp 5B2 to be kept in the normally-on state when the right radar sensor 2B2 detects that the distance between the moving object in the right blind zone and the automobile is smaller than 15 m, and the main control panel 3B2 can control the right indicator lamp 5B2 to flicker when the distance between the moving object and the automobile is smaller than 15 m and a rightward steering signal is detected, so that the driver is warned to pay attention to the automobile speed and the moving object in the right blind zone.

In the embodiment, the left radar sensor 2B1 and the right radar sensor 2B2 work at the same time, and the left indicator lamp 5B1 and the right indicator lamp 5B2 are light-emitting diodes which can emit red light or orange light; however, the left indicator lamp 5B1 and the right indicator lamp 5B2 are not limited to light-emitting diodes and can also be LED lamps, and all lamps which can achieve the warning function can be applied to the present invention.

In the embodiment, the automobile main controller 4 also reads signals of the left radar sensor 2B1 and the right radar sensor 2B2, a prompt alarm is given through an alarm module (not shown in FIGs) on the automobile main controller 4, the alarm module comprises a voice module or an in-vehicle indicator lamp alarm module, the voice module is connected with a horn, and the in-vehicle indicator lamp alarm module is electrically connected with an LED lamp or a light-emitting diode; when the alarm module on the automobile main controller 4 acquires a signal of the left radar sensor 2B1 or the right radar sensor 2B2, the distance between the moving object in the blind zone and the automobile and the automobile speed are both displayed on a control display screen (not shown in FIGs) on the automobile main controller 4; meanwhile, when the distance between the automobile and the moving object in the blind zone is smaller than 15 m or the automobile speed is higher than 20 km/h and a steering signal towards the moving object in the blind zone is obtained, the voice module on the alarm module and the in-vehicle indicator lamp alarm module give alarms.

The present invention has the advantages that:

1. The structure is simple, the radar sensors are arranged inside the license plate frame body without being exposed and affecting the appearance of the whole automobile and are better hidden, the connecting mode and the mounting mode are simple, and the practicability is high;

2. The structure is simple, the blind zones of automobile rearview mirrors can be monitored without additionally arranging extra parts, the operating principle is simple, the monitoring system is an independent detection system and can be in compatible connection with the automobile main controller to read and acquire data independently, and thus the applicability is high;

3. The operating principle is simple, the monitoring system is an independent detection system, can be applied to the license plate frame and the rearview mirrors, and can be in compatible connection with the automobile main controller to read and acquire data independently, and thus the applicability is high;

4. The monitoring speed in the whole process is high, the left radar sensor and the right radar sensor work separately and independently to monitor the scopes on the two sides respectively, and timely monitoring is achieved; the left indicator and the right indicator are used for displaying respectively so that whether a moving object exists in the blind zones can be judged rapidly, and the driver can drive more safely; collision accidents caused by lane changing or turning of the automobile are avoided, and driving is safer.

The embodiments disclosed above are only several specific embodiments of the present invention, however, the present invention is not limited to the above embodiments, and changes extrapolated by those skilled in the field are all within the protection scope of the present invention.

What is claimed is:

1. A blind zone monitoring method, performed by a radar sensor and a main control panel, wherein the radar sensor is connected with the main control panel and mounted on the left side and the right side of an automobile, and the main control panel is arranged in the automobile and connected with an automobile main controller; the method comprising:
when the automobile travels,
receiving and processing an automobile speed monitored by a GPS module and vehicle traveling conditions monitored by the radar sensor, in the blind zone at the two ends of the automobile through the main control panel;
detecting whether a moving object exists in the blind zone of a rearview mirror or not in real time, automatically detecting the distance between the object and the automobile if the moving object exists, and sending signals to a main control module through the radar sensor; when the radar sensor detect that the moving object exists in the blind zones and the distance between the moving object and the automobile is smaller than the early warning distance;
sending abnormal signals to the automobile main controller through the main control panel, and controlling an indicator to give an alarm as a prompt through the automobile main controller;
when the main control panel detects that the distance between the moving object in the blind zones and the automobile is smaller than the early warning distance and a steering lamp signal towards the moving object exists in the automobile main controller; and
sending abnormal signals to the automobile main controller through the main control panel, and controlling the indicator to give an alarm as a prompt through the automobile main controller.

2. The blind zone monitoring method according to claim 1, comprising the following steps of automatically acquiring the automobile speed signals in the GPS module and judging whether the automobile speed exceeds the early warning automobile speed or not through the main control panel when the information indicating that the moving object exists in the blind zones is received;
sending an abnormal signal to the automobile main controller through the main control panel when the automobile speed exceeds the early warning automobile speed;
controlling the indicator to give an alarm and to light up through the automobile main controller;
reading the automobile steering lamp information in the automobile main controller in real time and automatically judging whether an automobile steering lamp signal towards the moving object exists or not through the main control panel;
when the automobile steering lamp signal meeting the requirement exists, transmitting an abnormal signal to the automobile main controller through the main control panel, controlling the indicator to give an alarms through the automobile main controller, and reminding the driver of turning dangers.

3. A license plate frame device with a blind zone monitoring function, comprising a license plate frame body, a radar sensor and a main control panel, wherein the license number is displayed on an external baffle of the license plate frame body, the radar sensor and the main control panel are arranged inside the license plate frame body, the radar sensor is electrically connected with the main control panel, the main control panel is electrically connected with an automobile main controller and used for acquiring a power supply and transmitting data, the main control panel acquires automobile steering information through the automobile main controller and adopts the blind zone monitoring method according to claim 2, an indicator is arranged in an automobile cab and electrically connected with the automobile main controller, the main control panel sends signals monitored by the radar sensor to the automobile main controller, and the automobile main controller controls the indicator to act so as to remind the driver to pay attention to the driving condition.

4. The license plate frame device with the blind zone monitoring function according to claim 3, wherein there are two radar sensors, the two radar sensors are mounted at the left end and the right end of the license plate frame body respectively, a left radar device and a right radar device are electrically connected with the main control panel respectively, the left radar device is used for monitoring the road condition of the left side of the automobile, the right radar device is used for monitoring the road condition on the right side of the automobile, and the left radar device and the right radar device are electrically connected with the main control panel respectively.

5. The license plate frame device with the blind zone monitoring function according to claim 4, wherein the indicator comprises a voice alarm module and an LED indication module, wherein the voice alarm module and the LED indication module are electrically connected with the automobile main controller respectively, the voice alarm module controls a horn to send out alarm sounds after the automobile main controller receives an abnormal signal sent by the radar sensor, and the LED indication module controls an LED lamp to emit warning light.

6. The license plate frame device with the blind zone monitoring function according to claim 5, wherein the number of the indicators is two, the left indicator and the right indicator are electrically connected with the automobile main controller respectively, and the automobile main controller sends the monitoring information of the left radar device to the left indicator and simultaneously sends the monitoring information of the right radar device to the right indicator, and the left indicator is arranged on the left side of the right indicator.

7. The license plate frame device with the blind zone monitoring function according to claim 3, wherein the main control panel comprises a main control module, an information receiving module and an information sending module, wherein the information receiving module and the information sending module are electrically connected with the main control module, the information receiving module is electrically connected with the radar sensor and receives radar monitoring information sent by the radar sensor, the main control module is used for data processing of the radar monitoring information and transmits abnormal information to the automobile main controller through the information sending module, and the automobile main controller sends the abnormal information to the indicator as a prompt.

8. The license plate frame device with the blind zone monitoring function according to claim 7, wherein the main control panel further comprises a GPS module, wherein the GPS module is electrically connected with the main control module, the radar sensor and the main control panel acquire a power supply through the automobile main controller, the main control panel acquires a steering lamp signal through the automobile main controller, the GPS module measures the automobile speed and sends a measured automobile speed signal to the main control module, the radar sensor monitors the vehicle condition in the blind zone of the automobile rearview mirror in real time and transmits information to the main control module, the main control module acquires the automobile speed signal in the GPS module in real time and sends information subjected to data processing into the automobile main controller, and the working state of the indicator is controlled accordingly.

9. The license plate frame device with the blind zone monitoring function according to claim 4, wherein the blind zone position parameter, the early warning distance and the early warning automobile speed are set in the main control module, the radar sensors monitor objects by acquiring the blind zone position parameter in the main control module, the left radar sensor acquires left blind zone position parameter information in the automobile main controller, and the right radar sensor acquires right blind zone position parameter information in the automobile main controller.

10. The license plate frame device with the blind zone monitoring function according to claim 4, wherein the license plate frame body is of a square structure, the radar sensors are arranged at the two end positions in the license plate frame body, an included angle is formed between the left radar sensor and the left short edge of the license plate frame body, an included angle is formed between the right radar sensor and the right short edge of the license plate frame body, the monitoring scope of the left radar sensor covers a left blind zone, and the monitoring scope of the right radar sensor covers a right blind zone.

11. A rearview mirror, comprising a shell, a reflector and a main control panel, wherein the main control panel is embedded in an airtight cavity defined by the shell and the reflector, the main control panel adopts the blind zone monitoring method according to claim 2 the radar sensor and the indicator are electrically connected with the main control panel, the main control panel is electrically connected with the automobile main controller and also electrically connected with the indicator, an indicator display area is further arranged at the junction of the shell and the automobile, a transparent plastic cover plate is arranged in the indicator display area, and lamplight of the indicator lamp is diffused out through the transparent plastic cover plate in the indicator display area.

12. A storing device, comprising an execution program storing the method according to claim 2.
